(19) United States
(12) Patent Application Publication
(10) Pub. No.: US 2007/0040392 A1
(43) Pub. Date: Feb. 22, 2007

(54) Door checker for automobile

(75) Inventor: Katsuhiro Matsuki, Saitama (JP)

Correspondence Address: ARENT FOX PLLC, 1050 CONNECTICUT AVENUE, N.W., SUITE 400, WASHINGTON, DC, 20036, US

(73) Assignee: RIKENKAKI KOGYO KABUSHIKI KAISHA

(21) Appl. No.: 11/507,017

(22) Filed: Aug. 21, 2006

(30) Foreign Application Priority Data
Aug. 22, 2005 (JP) 2005-239634

(51) Int. Cl. E05C 17/04

(52) U.S. Cl. 292/262

(57) ABSTRACT

A door checker for an automobile, includes: a case 1 fixed to a door D; a check plate 6 which movably penetrates the case 1 and is turnably connected to a body B; a pair of upper and lower detent members 16 slidably held in the case 1 to hold the door D at a predetermined opening position in cooperation with a pair of upper and lower detent surfaces 10 of the check plate 6; and an elastic member 17 which is made of an elastic material for generating a detent force between the detent member 16 and the detent surface 10. In this door checker, a drain hole 20 is provided in the check plate 6 in a portion projecting into the door D from the case 1 and at least at a position close to the case 1 as to penetrate the upper and lower detent surfaces 10 when the door is fully closed. Thus, even if rainwater and the like go into the door D and drop onto the upper surface of the check plate 6, it is drained quickly from the check plate 6 and are prevented from flowing into the case 1.

### RELATED APPLICATION DATA

The present invention is based upon Japanese priority application No. 2005-239634, which is hereby incorporated in its entirety herein by reference.

### BACKGROUND OF THE INVENTION

1. Field of the Invention

The present invention relates to an improvement of a door checker for an automobile comprising: a case turnably fixed to a door pivotally supported on a body of the automobile; a check plate which movably penetrates the case and is turnably connected to the body; a pair of upper and lower detent members slidably held in the case to hold the door at a predetermined opening position in cooperation with a pair of upper and lower detent surfaces of the check plate; and an elastic member which is made of an elastic material and which is compressedly provided in the case to generate a detent force between the detent member and the detent surface.

2. Description of the Related Art

Such a door checker has been already known as disclosed in Japanese Patent Application Laid-Open No. 9-256714.

In this door checker for an automobile, when the door is fully closed, the check plate projects deeply into the door from the case. Since rainwater or car washing water goes into the door in some amount through a door-windowpane accommodation-slit, if the water droplets drop onto the upper surface of the check plate, they often flow into the case while being accompanied by dust adhering to the upper surface. Because of this inflow, the dust is caught in clearances between the case and the detent member and between the case and the elastic member, leading to problems that abnormal noise is generated and the slidability of the detent member in the case is deteriorated to change its checking characteristics.

In a known counter measure, the case and the check plate are covered with a cover to prevent rainwater and the like from flowing into the case. However, even this counter measure cannot completely achieve the waterproofing of the case, and entails an increased number of parts to increase the cost.

### SUMMARY OF THE INVENTION

The present invention has been achieved in view of the above-mentioned circumstances, and has an object to provide a door checker for an automobile in which even if rainwater and the like go into the door and drop onto the upper surface of a check plate, it is drained quickly from the check plate and are prevented from flowing into the case, thereby avoiding the above-mentioned problems.

In order to achieve the above object, according to a first feature of the present invention, there is provided a door checker for an automobile comprising: a case turnably fixed to a door pivotally supported on a body of the automobile; a check plate which movably penetrates the case and is turnably connected to the body; a pair of upper and lower detent members slidably held in the case to hold the door at a predetermined opening position in cooperation with a pair of upper and lower detent surfaces of the check plate; and an elastic member which is made of an elastic material and which is compressedly provided in the case to generate a detent force between the detent member and the detent surface, wherein a drain hole is provided in the check plate in a portion projecting into the door and at least at a position close to the case so as to penetrate the upper and lower detent surfaces when the door is fully closed.

With the first feature of the present invention, when the door is fully closed, even if droplets of rainwater or car washing water go into the door and drop onto the upper detent surface of the check plate projecting deeply into the door from the case and flow to the case side while being accompanied by dust, the water droplets are caught by and drop into the drain hole together with dust before reaching the case. Therefore, the droplets and dust can be prevented from flowing into the case. Thus, various troubles caused by the dust caught in the clearances between the case and the detent member and between the case and the elastic member can be prevented. Moreover, the door checker does not use any dedicated cover or the like, whereby the door checker having a simple structure can be provided at a low cost.

According to a second feature of the present invention, in addition to the first feature, the check plate comprises a plate body made of a steel plate, and a synthetic resin covering body which covers the plate body to form the detent surfaces; and the drain hole comprises a small-diameter hole provided in the plate body, and large-diameter holes which are provided in the covering body and are vertically aligned with the small-diameter hole.

With the second feature of the present invention, the water droplets can be caught effectively by the large-diameter holes in the synthetic resin covering body. Also, the strength of the check plate can be secured because a large-diameter hole is not required to be provided in the plate body.

According to a third feature of the present invention, in addition to the first feature, a guide groove is provided in the upper detent surface guide water droplets flowing on the upper detent surfaceward the case to the drain hole.

With the third feature of the present invention, the water droplets flowing on the upper detent surface toward the case are reliably caught by the pair of guide grooves, and are guided to the first drain hole. Therefore, it is possible to more reliably prevent the water droplets and dust from flowing into the case.

According to a fourth feature of the present invention, there is provided a door checker for an automobile comprising: a case turnably fixed to a door pivotally supported on a body of the automobile; a check plate which movably penetrates the case and is turnably connected to the body; a pair of upper and lower detent members slidably held in the case to hold the door at a predetermined opening position in cooperation with a pair of upper and lower detent surfaces of the check plate; and an elastic member which is made of an elastic material and which is compressedly provided in the case to generate a detent force between the detent member and the detent surface, wherein a drain hole is provided in the check plate in a portion projecting into the door and in the upper detent surface at least at a position close to the case so as to open on opposite outer sides of the check plate when the door is fully closed.

With the fourth feature of the present invention, when the door is fully closed, even if droplets of rainwater or car washing water go into the door and drop onto the upper detent surface of the check plate projecting deeply into the door from the case and flow to the case side while being accompanied by dust, the water droplets are caught by the drain hole, guided to opposite outer sides of the check plate, and drop, before reaching the case. Therefore, the droplets and dust can be prevented from flowing into the case. Thus, various troubles caused by the dust caught in the clearances between the case and the detent member and between the case and the elastic member can be prevented. Moreover, the door checker does not use any dedicated cover or the like, whereby the door checker having a simple structure can be provided at a low cost.

The above-mentioned object, other objects, characteristics, and advantages of the present invention will become apparent from preferred embodiments, which will be described in detail below with reference to the attached drawings.

### BRIEF DESCRIPTION OF THE DRAWINGS

FIG. 1 is a perspective view of an essential portion of an automobile equipped with a door checker according to a first embodiment of the present invention.

FIG. 2 is a plan view of an essential portion of the door checker.

FIG. 3 is a sectional view taken along line 3-3 of FIG. 2.

FIG. 4 is an enlarged view of the portion 4 in FIG. 2.

FIG. 5 is a sectional view taken along line 5-5 of FIG. 4.

FIG. 6 is an exploded perspective view of an essential portion of the door checker.

FIG. 7 is a plan view corresponding to FIG. 2 but showing a second embodiment of the present invention.

FIG. 8 is a sectional view taken along line 8-8 of FIG. 7.

FIG. 9 is a sectional view taken along line 9-9 of FIG. 8.

### DESCRIPTION OF THE PREFERRED EMBODIMENT

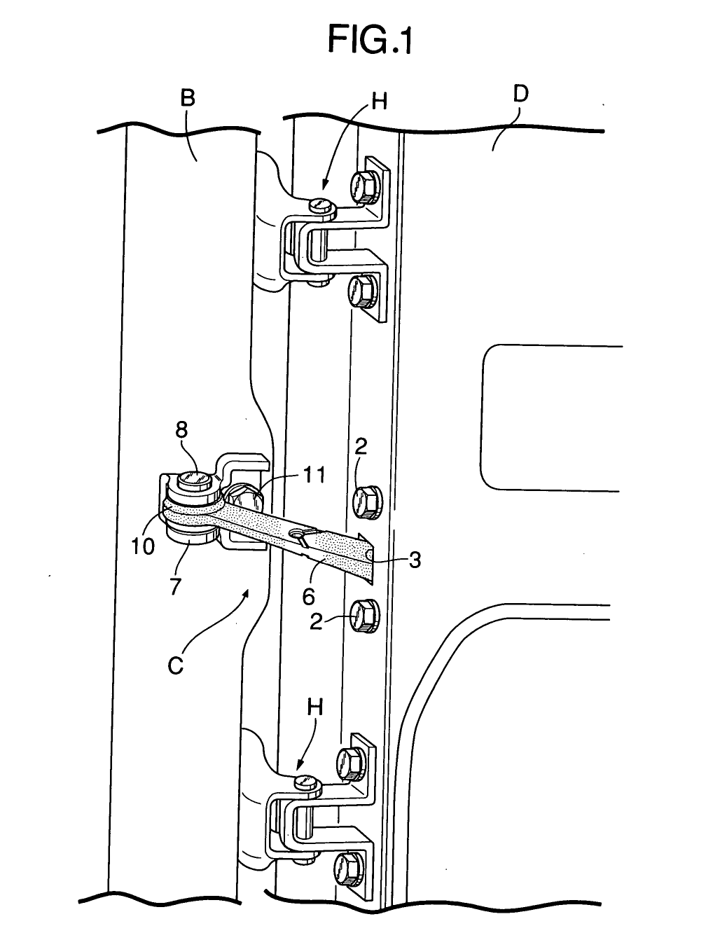

First, a first embodiment of the present invention shown in FIGS. 1 to 6 will be described.

In FIG. 1, a door D for opening/closing an entrance is turnably attached to a body B of an automobile via hinges H. A door checker C according to the present invention is mounted between the body B and the door D.

As shown in FIGS. 1 to 3, the door checker C has a case 1 fixed to the inner surface of an end wall of the door D. The case 1 includes a case body 1a having a box shape whose one end is open, and a cover 1b connected to the case body 1a while covering the open end thereof. The case body 1a and the cover 1b are fastened to the inner surface of the end wall of the door D with a pair of upper and lower bolts 2 in a state in which the cover 1b is brought into contact with the inner surface of the end wall. The cover 1b and the case body 1a have through holes 4 and 5, respectively, which are aligned coaxially with a through hole 3 that is formed in the end wall of the door D. The base end of a check plate 6 penetrating these three through holes 3, 4 and 5 is mutually turnably connected to a bracket 7 via a pivot pin 8. The bracket 7 is fixed to the body B with a bolt 9, while the pivot pin 8 is arranged in parallel with the pivot axis of the hinges H. The check plate 6 is arranged substantially in the horizontal direction, and its upper and lower surfaces are designed so as to serve as detent surfaces 10.

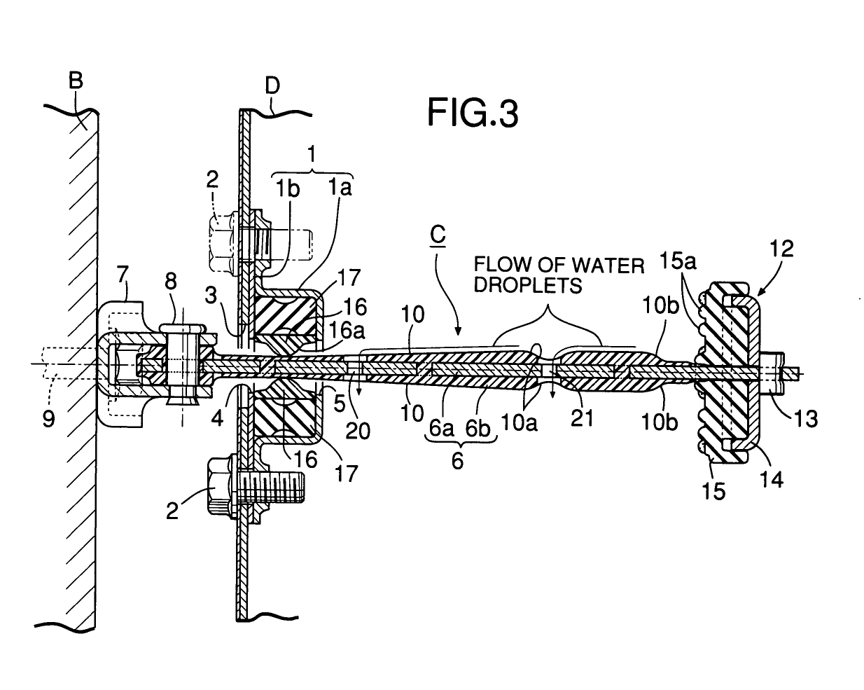

The check plate 6 comprises: a plate body 6a which is made of a steel plate and which is directly connected to the bracket 7 and arranged substantially in the horizontal direction; and a synthetic resin covering body 6b which is mold-connected to the plate body 6a so as to cover the peripheral surface of the plate body 6a excluding one end portion of the plate body 6a (see FIGS. 3 and 5). The covering body 6b is formed so that the distance between the upper and lower detent surfaces 10 of the check plate 6 gradually increases from the base end side (the bracket 7 side) of the plate 6 toward the free end side. Each of the detent surfaces 10 has a half-open detent notch 10a in its lengthwise intermediate portion, and a full-open detent notch 10b in the vicinity of the free end portion. A full-open stopper 12 is provided in the plate body 6a adjacently to the full-open detent notches 10b. The full-open stopper 12 includes: a stopper plate 14 made of a steel plate and fixed to the plate body 6a with a pin 13; and a stopper rubber 15 that is mounted on the stopper plate 14 so as to face the full-open detent notches 10b. A large number of cushion protrusions 15a are bulgingly provided on the end surface of the stopper rubber 15 which faces the full-open detent notches 10b.

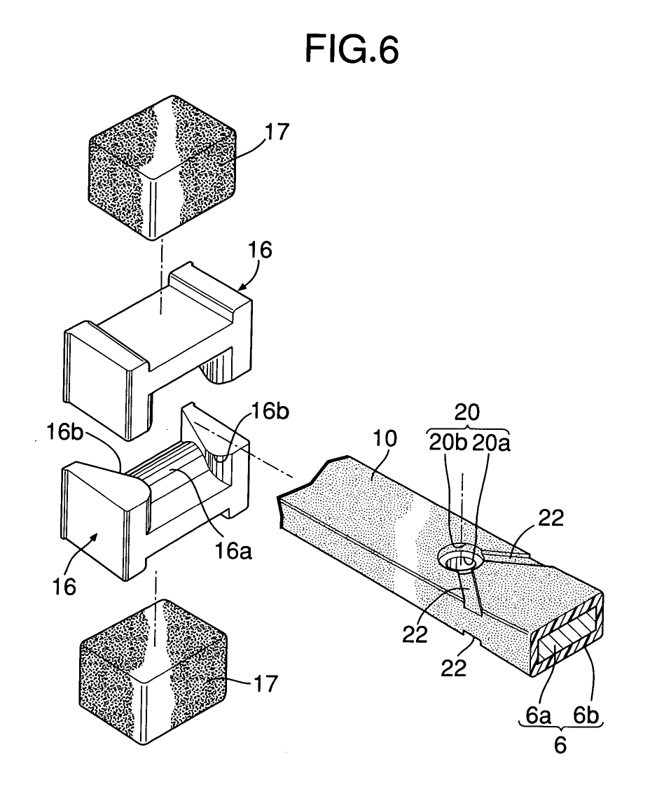

In FIGS. 3 and 6, in the case 1, a pair of upper and lower synthetic resin detent members 16 are fitted and held so as to be slidable along the thicknesswise direction of the check plate 6 to hold the door D at a predetermined opening position in cooperation with the pair of detent surfaces 10 of the check plate 6. Each of the detent members 16 has a semicylindrical engagement portion 16a capable of engaging with the half-open detent notch 10a and the full-open detent notch 10b. Also, each of the detent members 16 has guide walls 16b for slidably supporting opposite side surfaces of the check plate 6 in cooperation with each other.

Further, in the case 1, a pair of upper and lower elastic members 17 that elastically urge the detent members 16 against the detent surfaces 10 of the check plate 6 are housed in a compressed state. The elastic member 17 is formed of an elastic material such as elastomer.

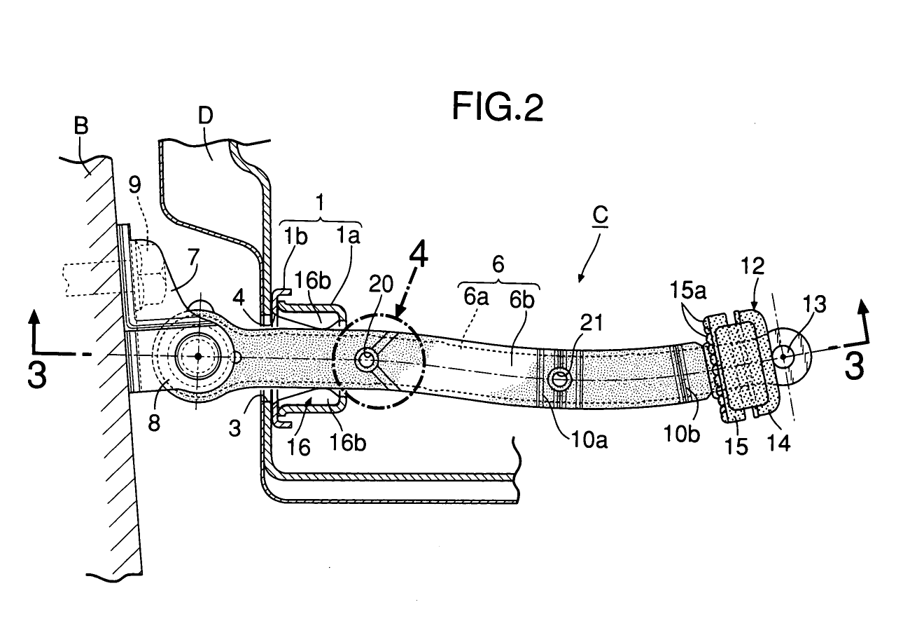

FIGS. 2 and 3 show a state of the door checker C when the door D is fully closed. At this time, the check plate 6 is in a state in which its portion on the full-open stopper 12 side projects deeply into the door D from the case 1. A first drain hole 20 penetrating the upper and lower detent surfaces 10 is provided in the check plate 6 in a portion projecting deeply into the door D from the case 1 and at a position close to the case 1 so as to penetrate the upper and lower detent surfaces 10. The first drain hole 20 comprises a small-diameter hole 20a provided in the plate body 6a made of a steel plate, and large-diameter holes 20b that are provided in the synthetic resin covering body 6b and are vertically aligned with the small-diameter hole 20a.

Furthermore, a pair of guide grooves 22 having a chevron-shaped arrangement are formed in each of the upper and lower detent surfaces 10. The guide grooves 22 widen from the upper and lower opening ends of the first drain hole 20 toward the full-open stopper 12, and are open on opposite side surfaces of the check plate 6.

Further, the check plate 6 is provided with a second drain hole 21 that is located on the full-open stopper 12 side with respect to the first drain hole 20, and vertically penetrates the bottom portions of the upper and lower half-open detent notches 10a. The second drain hole 21 also comprises a small-diameter hole 20a in the plate body 6a, and large-diameter holes 20b in the covering body 6b, as in the case of the first drain hole 20.

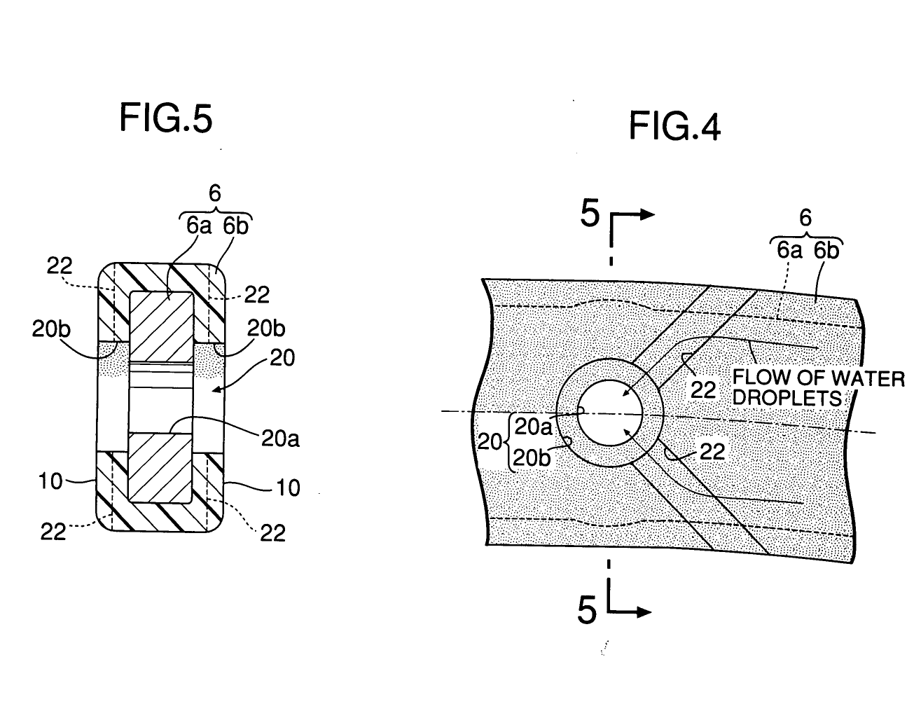

As shown in FIGS. 4 and 5, each of the first drain hole 20 and the second drain hole 21 comprises the small-diameter hole 20a provided in the plate body 6a made of a steel plate, and large-diameter holes 20b provided in the upper and lower portions of the synthetic resin covering body 6b.

Next, the operation of this embodiment will be described.

As the door D is opened from the fully closed position, the engagement portions 16a of the detent members 16 correspondingly slide on the detent surfaces 10 of the check plate 6 so as to go up the detent surfaces 10, and the elastic members 17 are accordingly compressed. Therefore, the increase in repulsive forces of the elastic members 17 gradually increases the pressing forces of the detent members 16 applied to the detent surfaces 10, thereby moderately increasing the opening torque of the door D.

When the door D reaches a predetermined half-open position, the engagement portions 16a of the detent members 16 are dropped into the half-open detent notches 10a of the check plate 6 by the elastic forces of the elastic members 17, thereby suddenly increasing the opening torque of the door D. Therefore, the door D can be held at a predetermined half opened position.

When an opening force is further applied to the door D to cause the engagement portions 16a of the detent members 16 to get out of the half-open detent notches 10a, and the door D reaches a predetermined fully opened position, the engagement portions 16a drop into the full-open detent notches 10b, and at the same time the case 1 is elastically received by the stopper rubber 15. Therefore, the door D can be held at the fully opened position.

Also in the process of closing the door D from the fully opened position, in the same way as described, the door D can be held at the predetermined half opened position by the engagement between the engagement portions 16a of the detent members 16 and the half open detent notches 10a. Further, when the door D is closed, the engagement portions 16a of the detent members 16 slide down on the detent surfaces 10 of the check plate 6, thereby moderately decreasing the closing torque of the door D. Therefore, the door D can be smoothly closed.

When the door D is in the fully closed state, if droplets of rainwater or car washing water go into the door D and drop onto the upper detent surface 10 of the check plate 6 projecting deeply into the door D from the case 1, the water droplets go down the upper detent surface 10 while being accompanied by dust adhering to the upper detent surface 10, because the upper detent surface 10 has a gradient going down toward the case 1. However, since the vertically-arranged first drain hole 20 and second drain hole 21 are provided in the check plate 6 at the position just in front of the case 1 and in the bottom portions of the half open detent notches 10a, respectively, the water droplets having dropped into the half-open detent notch 10a are caught by and drop into the second drain hole 21 together with the dust. Also, the water droplets going down on the case 1 side with respect to the half-open detent notch 10a are caught by and drop into the first drain hole 20 together with the dust just before reaching the case 1. Therefore, the droplets and dust can be prevented from flowing into the case 1. Thus, various troubles caused by the dust caught in the clearances between the case 1 and the detent member 16 and between the case 1 and the elastic member 17 can be prevented. Moreover, the door checker C does not use any dedicated cover or the like, whereby the door checker C having a simple structure can be provided at a low cost.

In particular, the first drain hole 20 and the second drain hole 21 are each formed by vertically arranging the small-diameter hole 20a provided in the plate body 6a made of a steel plate, which is a strength member of the check plate 6, and the large-diameter holes 20b provided in the synthetic resin covering body 6b. Therefore, the water droplets can be caught effectively by the large-diameter holes 20b, and also the strength of the check plate 6 can be secured because a large-diameter hole is not required to be provided in the plate body 6a.

Also, since each of the detent surfaces 10 has the pair of guide grooves 22 having a chevron-shaped arrangement, which widen from the upper and lower opening ends of the first drain hole 20 toward the full-open stopper 12 side and are open on opposite side surfaces of the check plate 6, the water droplets flowing on the upper detent surface 10 toward the case 1 are reliably caught by the pair of guide grooves 22, and are guided to the first drain hole 20. Therefore, it is possible to more reliably prevent the water droplets and dust from flowing into the case 1. In the case where the guide grooves 22 are provided in this manner, the hole provided in the covering body 6b can have the same diameter as that of the small-diameter hole 20a in the plate body 6a.

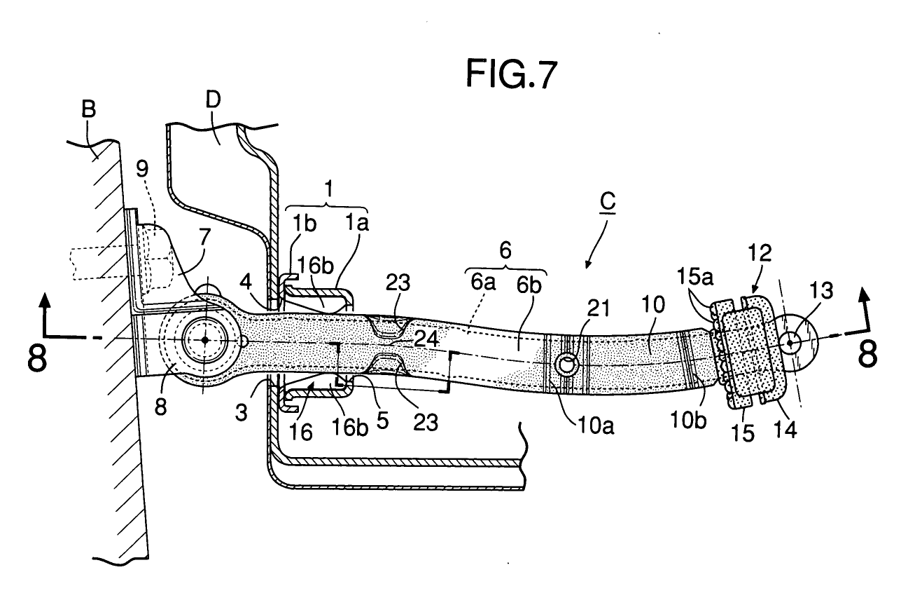

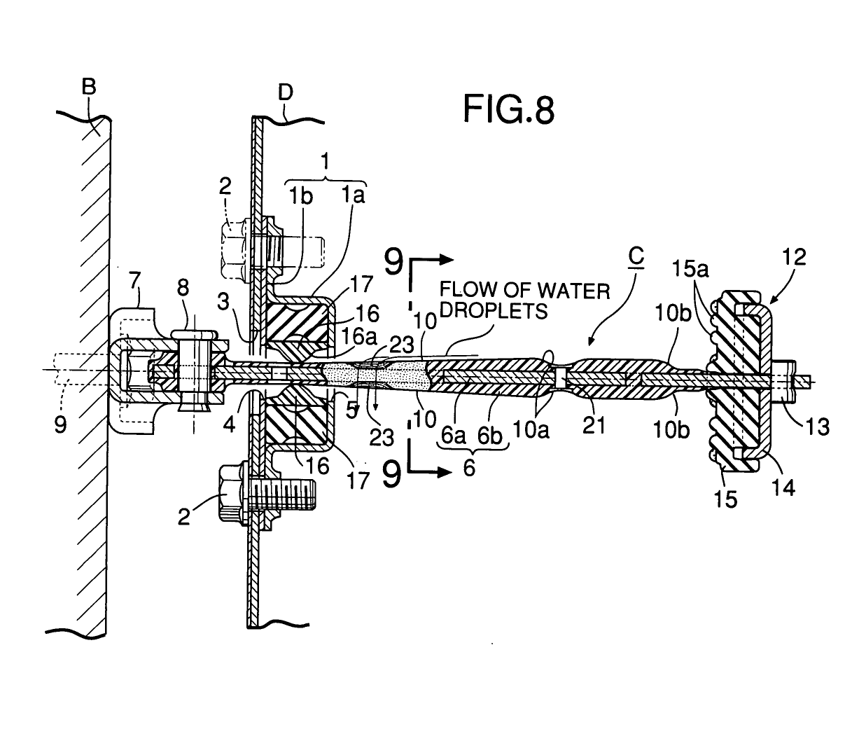

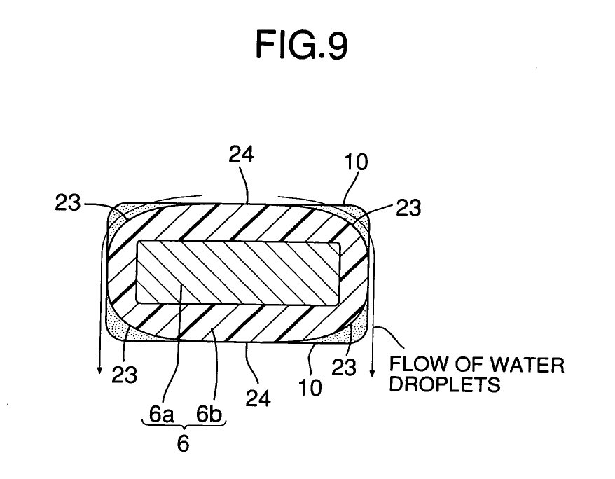

Next, a second embodiment of the present invention shown in FIGS. 7 to 9 will be described.

In the second embodiment, in place of the first drain hole 20, a pair of outwardly sloping-down drain grooves 23 are formed in the check plate 6 in a portion projecting deeply into the door D and in the upper and lower detent surface 10 at a position close to the case 1, while land portions 24 are left between the drain grooves 23. The other portions are the same as those in the first embodiment. Therefore, the portions corresponding to those in the first embodiment in FIGS. 7 to 9 are denoted by the same reference numerals, and duplicated description thereof is omitted.

According to the second embodiment, even if droplets of rainwater or car washing water go into the door D and drop onto the upper detent 10 of the check plate 6, and flow to the case 1 side while being accompanied by dust, most of the water droplets are caught by the pair of the drain grooves 23 and are guided to opposite outer sides of the check plate 6 and drop, before the droplets reach the case 1. Therefore, the droplets and dust can be prevented from flowing into the case 1. Thus, as in the case of the first embodiment, various troubles caused by the dust caught in the clearances between the case 1 and the detent member 16 and between the case 1 and the elastic member 17 can be prevented.

Further, since the land portion 24 is present between the pair of drain grooves 23, the detent members 16 slide on the land portions 24 continuous with the detent surfaces 10 when the door D is opened or closed, thereby preventing an uncomfortable feeling to be given to a passenger. Furthermore, also the door checker C of this embodiment does not use any dedicated cover or the like, whereby the door checker C having a simple structure can be provided at a low cost.

In the above-described embodiments, the guide grooves 22 and the drain grooves 23 are provided on both the upper and lower detent surfaces 10. This is because even if the check plate 6 is arranged upside down in the right and left door checker C of the automobile, the guide grooves 22 and the drain grooves 23 can perform the desired function.

The present invention is not limited to the above-described embodiments, and various design changes can be made without departing from the spirit and scope of the invention. For example, if the drain grooves 23 in the second embodiment are modified so as to have a V shape in which the bent portion is directed to the full-open stopper 12 side or a straight-line shape which is inclined with respect to the longitudinal direction of the check plate 6, the water droplets can be caught and drained without leaving the land portions on the detent surfaces 10, without giving an uncomfortable feeling to the passenger opening or closing the door. Also, the present invention is effective for a door checker in which the upper and lower detent surfaces 10 of the check plate 6 are horizontally arranged. Specifically, although the water droplets having dropped onto the horizontal detent surface 10 also flow often to the case 1 side depending on the posture and driving conditions of the automobile such as acceleration and deceleration, the water droplets are caught and drained by the drain hole or the drain groove in front of the case 1, whereby the water droplets can be prevented from flowing into the case 1.

What is claimed is:

1. A door checker for an automobile comprising:
a case turnably fixed to a door pivotally supported on a body of the automobile;
a check plate which movably penetrates the case and is turnably connected to the body;
a pair of upper and lower detent members slidably held in the case to hold the door at a predetermined opening position in cooperation with a pair of upper and lower detent surfaces of the check plate; and
an elastic member which is made of an elastic material and which is compressedly provided in the case to generate a detent force between the detent member and the detent surface,
wherein a drain hole is provided in the check plate in a portion projecting into the door and at least at a position close to the case so as to penetrate the upper and lower detent surfaces when the door is fully closed.

2. The door checker for an automobile according to claim 1, wherein the check plate comprises a plate body made of a steel plate, and a synthetic resin covering body which covers the plate body to form the detent surfaces; and the drain hole comprises a small-diameter hole provided in the plate body, and large-diameter holes which are provided in the covering body and are vertically aligned with the small-diameter hole.

3. The door checker for an automobile according to claim 1, wherein a guide groove is provided in the upper detent surface guide water droplets flowing on the upper detent surfaceward the case to the drain hole.

4. A door checker for an automobile comprising:
a case turnably fixed to a door pivotally supported on a body of the automobile;
a check plate which movably penetrates the case and is turnably connected to the body;
a pair of upper and lower detent members slidably held in the case to hold the door at a predetermined opening position in cooperation with a pair of upper and lower detent surfaces of the check plate; and
an elastic member which is made of an elastic material and which is compressedly provided in the case to generate a detent force between the detent member and the detent surface,
wherein a drain hole is provided in the check plate in a portion projecting into the door and in the upper detent surface at least at a position close to the case so as to open on opposite outer sides of the check plate when the door is fully closed.
